(19) United States
(12) Patent Application Publication
(10) Pub. No.: US 2003/0007700 A1
(43) Pub. Date: Jan. 9, 2003

(54) Method and apparatus for interleaving a user image in an original image sequence

(75) Inventors: Srinivas Gutta, Buchanan, NY (US); Miroslav Trajkovic, Ossining, NY (US); Antonio J. Colmenarez, Peekskill, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/898,139

(22) Filed: Jul. 3, 2001

(51) Int. Cl. G06K 9/20

(52) U.S. Cl. 382/282

(57) ABSTRACT

An image processing system is disclosed that allows a user to participate in a given content selection or to substitute any of the actors or characters in the content selection. A user can modify an image by replacing an image of an actor with an image of the corresponding user (or a selected third party). Various parameters associated with the actor to be replaced are estimated for each frame. A static model is obtained of the user (or the selected third party). A face synthesis technique modifies the user model according to the estimated parameters associated with the selected actor. A video integration stage superimposes the modified user model over the actor in the original image sequence to produce an output video sequence containing the user (or selected third party) in the position of the original actor.

### FIELD OF THE INVENTION

The present invention relates to image processing techniques, and more particularly, to a method and apparatus for modifying an image sequence to allow a user to participate in the image sequence.

### BACKGROUND OF THE INVENTION

The consumer marketplace offers a wide variety of media and entertainment options. For example, various media players are available that support various media formats and can present users with virtually an unlimited amount of media content. In addition, various video game systems are available that support various formats and allow users to play a virtually unlimited amount of video games. Nonetheless, many users can quickly get bored with such traditional media and entertainment options.

While there may be numerous content options, a given content selection generally has a fixed cast of actors or animated characters. Thus, many users often lose interest while watching the cast of actors or characters in a given content selection, especially when the actors or characters are unknown to the user. In addition, many users would like to participate in a given content selection or to view the content selection with an alternate set of actors or characters. There is currently no mechanism available, however, that allows a user to participate in a given content selection or to substitute any of the actors or characters in the content selection.

A need therefore exists for a method and apparatus for modifying an image sequence to contain an image of a user. A further need exists for a method and apparatus for modifying an image sequence to allow a user to participate in the image sequence.

### SUMMARY OF THE INVENTION

Generally, an image processing system is disclosed that allows a user to participate in a given content selection or to substitute any of the actors or characters in the content selection. The present invention allows a user to modify an image or image sequence by replacing an image of an actor in an original image sequence with an image of the corresponding user (or a selected third party).

The original image sequence is initially analyzed to estimate various parameters associated with the actor to be replaced for each frame, such as the actor's head pose, facial expression and illumination characteristics. A static model is also obtained of the user (or the selected third party). A face synthesis technique modifies the user model according to the estimated parameters associated with the selected actor, so that if the actor has a given head pose and facial expression, the static user model is modified accordingly. A video integration stage superimposes the modified user model over the actor in the original image sequence to produce an output video sequence containing the user (or the selected third party) in the position of the original actor.

A more complete understanding of the present invention, as well as further features and advantages of the present invention, will be obtained by reference to the following detailed description and drawings.

### BRIEF DESCRIPTION OF THE DRAWINGS

FIG. 1 illustrates an image processing system in accordance with the present invention;

FIG. 2 illustrates a global view of the operations performed in accordance with the present invention;

FIG. 3 is a flow chart describing an exemplary implementation of the facial analysis process of FIG. 1;

FIG. 4 is a flow chart describing an exemplary implementation of the face synthesis process of FIG. 1; and

FIG. 5 is a flow chart describing an exemplary implementation of the video integration process of FIG. 1.

### DETAILED DESCRIPTION

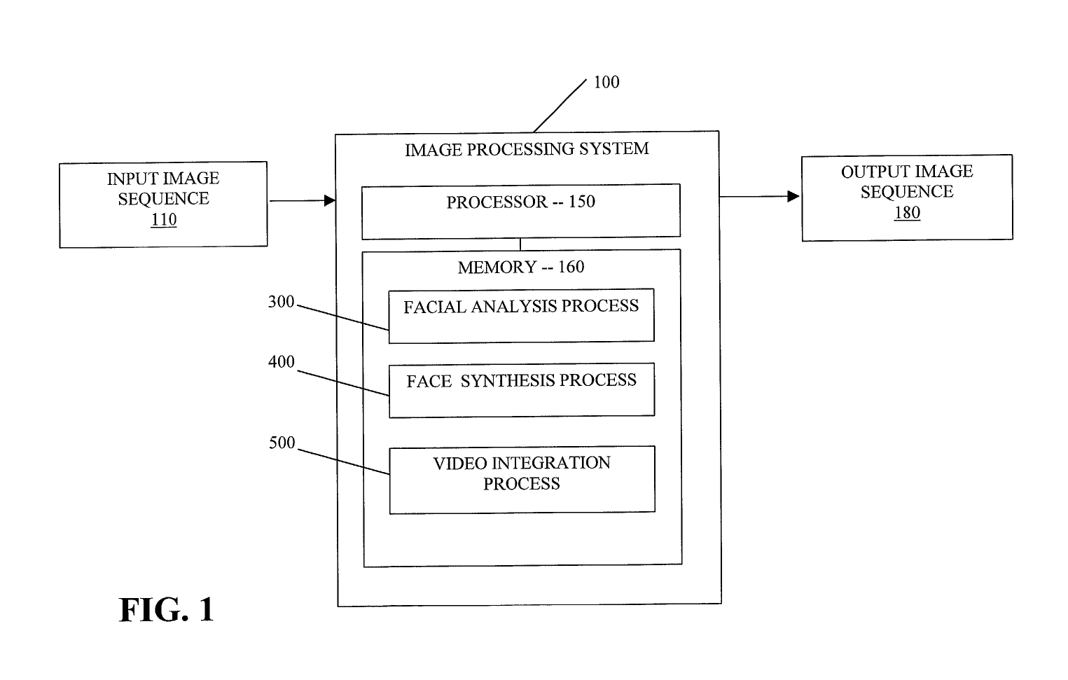

FIG. 1 illustrates an image processing system 100 in accordance with the present invention. According to one aspect of the present invention, the image processing system 100 allows one or more users to participate in an image or image sequence, such as a video sequence or video game sequence, by replacing an image of an actor (or a portion thereof, such as the actor's face) in an original image sequence with an image of the corresponding user (or a portion thereof, such as the user's face). The actor to be replaced may be selected by the user from the image sequence, or may be predefined or dynamically determined. In one variation, the image processing system 100 can analyze the input image sequence and rank the actors included therein based on, for example, the number of frames in which the actor appears, or the number of frames in which the actor has a close-up.

The original image sequence is initially analyzed to estimate various parameters associated with the actor to be replaced for each frame, such as the actor's head pose, facial expression and illumination characteristics. In addition, a static model is obtained of the user (or a third party). The static model of the user (or the third party) may be obtained from a database of faces or a two or three-dimensional image of the user's head may be obtained. For example, the Cyberscan optical measurement system, commercially available from CyberScan Technologies of Newtown, PA., can be used to obtain the static models. A face synthesis technique is then employed to modify the user model according to the estimated parameters associated with the selected actor. More specifically, the user model is driven by the actor parameters, so that if the actor has a given head pose and facial expression, the static user model is modified accordingly. Finally, a video integration stage overlays or superimposes the modified user model over the actor in the original image sequence to produce an output video sequence containing the user in the position of the original actor.

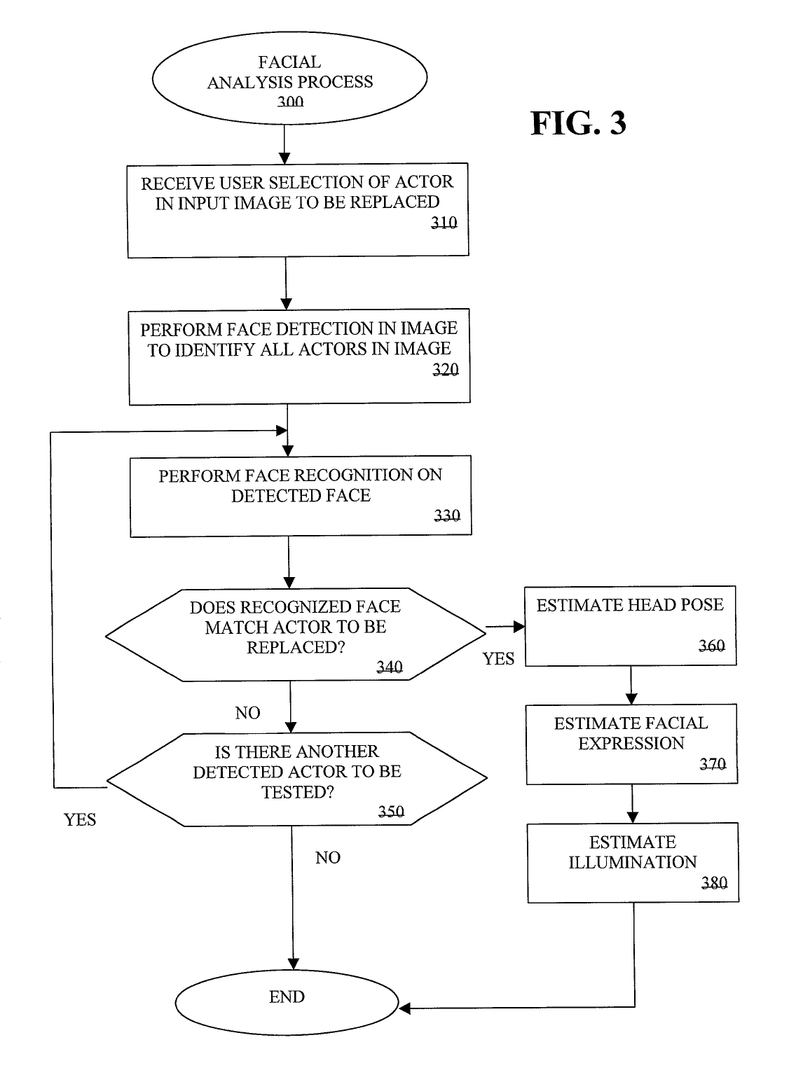

The image processing system 100 may be embodied as any computing device, such as a personal computer or workstation, containing a processor 150, such as a central processing unit (CPU), and memory 160, such as RAM and ROM. In an alternate embodiment, the image processing system 100 disclosed herein can be implemented as an application specific integrated circuit (ASIC) , for example, as part of a video processing system or a digital television. As shown in FIG. 1, and discussed further below in conjunction with FIGS. 3 through 5, respectively, the memory 160 of the image processing system 100 includes a facial analysis process 300, a face synthesis process 400 and a video integration process 500.

Generally, the facial analysis process 300 analyzes the original image sequence 110 to estimate various parameters of interest associated with the actor to be replaced, such as the actor's head pose, facial expression and illumination characteristics. The face synthesis process 400 modifies the user model according to the parameters generated by the facial analysis process 300. Finally, the video integration process 500 superimposes the modified user model over the actor in the original image sequence 110 to produce an output video sequence 180 containing the user in the position of the original actor.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

Memory 160 will configure the processor 150 to implement the methods, steps, and functions disclosed herein. The memory 160 could be distributed or local and the processor could be distributed or singular. The memory 160 could be implemented as an electrical, magnetic or optical memory, or any combination of these or other types of storage devices. The term “memory” should be construed broadly enough to encompass any information able to be read from or written to an address in the addressable space accessed by processor 150. With this definition, information on a network is still within memory 160 of the image processing system 100 because the processor 150 can retrieve the information from the network.

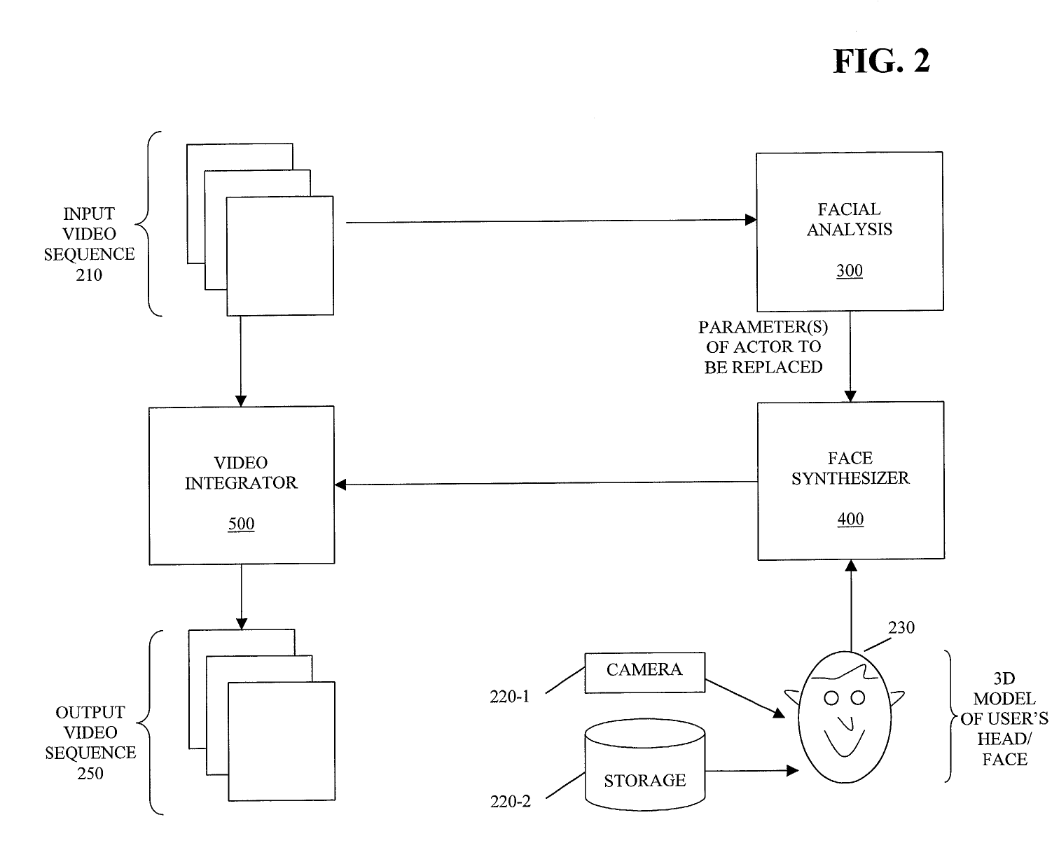

FIG. 2 illustrates a global view of the operations performed by the present invention. As shown in FIG. 2, each frame of an original image sequence 210 is initially analyzed by the facial analysis process 300, discussed below in conjunction with FIG. 3, to estimate the various parameters of interest for the actor to be replaced, such as the actor's head pose, facial expression and illumination characteristics. In addition, a static model 230 is obtained of the user (or a third party), for example, from a camera 220-1 focused on the user, or from a database of faces 220-2. The manner in which the static model 230 is generated is discussed further below in a section entitled “3D Model of Head/Face.”

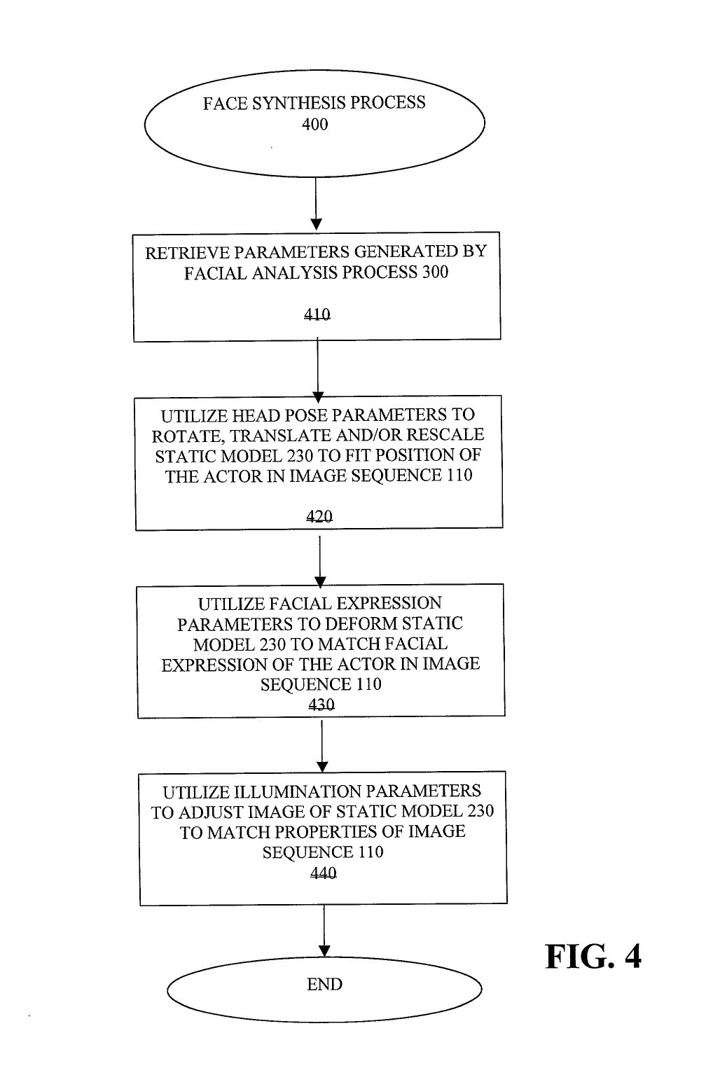

Thereafter, the face synthesis process 400, discussed below in conjunction with FIG. 4, modifies the user model 230 according to the actor parameters generated by the facial analysis process 300. Thus, the user model 230 is driven by the actor parameters, so that if the actor has a given head pose and facial expression, the static user model is modified accordingly. As shown in FIG. 2, the video integration process 500 superimposes the modified user model 230′ over the actor in the original image sequence 210 to produce an output video sequence 250 containing the user in the position of the original actor.

FIG. 3 is a flow chart describing an exemplary implementation of the facial analysis process 300. As previously indicated, the facial analysis process 300 analyzes the original image sequence 110 to estimate various parameters of interest associated with the actor to be replaced, such as the actor's head pose, facial expression and illumination characteristics.

As shown in FIG. 3, the facial analysis process 300 initially receives a user selection of the actor to be replaced during step 310. As previously indicated, a default actor selection may be employed or the actor to be replaced may be automatically selected based on, e.g., the frequency of appearance in the image sequence 110. Thereafter, the facial analysis process 300 performs face detection on the current image frame during step 320 to identify all actors in the image. The face detection may be performed in accordance with the teachings described in, for example, International Patent WO9932959, entitled “Method and System for Gesture Based Option Selection, assigned to the assignee of the present invention, Damian Lyons and Daniel Pelletier, “A Line-Scan Computer Vision Algorithm for Identifying Human Body Features,” Gesture'99, 85-96 France (1999), Ming-Hsuan Yang and Narendra Ahuja, “Detecting Human Faces in Color Images,” Proc. of the 1998 IEEE Int'l Conf. on Image Processing (ICIP 98), Vol. 1, 127-130, (October, 1998); and I. Haritaoglu, D. Harwood, L. Davis, “Hydra: Multiple People Detection and Tracking Using Silhouettes,” Computer Vision and Pattern Recognition, Second Workshop of Video Surveillance (CVPR, 1999), each incorporated by reference herein.

Thereafter, face recognition techniques are performed during step 330 on one of the faces detected in the previous step. The face recognition may be performed in accordance with the teachings described in, for example, Antonio Colmenarez and Thomas Huang, “Maximum Likelihood Face Detection,” 2nd Int'l Conf. on Face and Gesture Recognition, 307-311, Killington, Vt. (Oct. 14-16, 1996) or Srinivas Gutta et al., “Face and Gesture Recognition Using Hybrid Classifiers,” 2d Int'l Conf. on Face and Gesture Recognition, 164-169, Killington, Vt. (Oct. 14-16, 1996), incorporated by reference herein.

A test is performed during step 340 to determine if the recognized face matches the actor to be replaced. If it is determined during step 340 that the current face does not match the actor to be replaced, then a further test is performed during step 350 to determine if there is another detected actor in the image to be tested. If it is determined during step 350 that there is another detected actor in the image to be tested, then program control returns to step 330 to process another detected face, in the manner described above. If, however, it is determined during step 350 that there are no additional detected actors in the image to be tested, then program control terminates.

If it was determined during step 340 that the current face does match the actor to be replaced, then the head pose of the actor is estimated during step 360, the facial expression is estimated during step 370 and the illumination is estimated during step 380. The head pose of the actor may be estimated during step 360, for example, in accordance with the teachings described in Srinivas Gutta et al., “Mixture of Experts for Classification of Gender, Ethnic Origin and Pose of Human Faces,” IEEE Transactions on Neural Networks, 11(4), 948-960 (July 2000), incorporated by reference herein. The facial expression of the actor may be estimated during step 370, for example, in accordance with the teachings described in Antonio Colmenarez et al., “A Probabilistic Framework for Embedded Face and Facial Expression Recognition,” Vol. I, 592-597, IEEE Conference on Computer Vision and Pattern Recognition, Fort Collins, Colo. (Jun. 23-25, 1999), incorporated by reference herein. The illumination of the actor may be estimated during step 380, for example, in accordance with the teachings described in J. Stauder, “An Illumination Estimation Method for 3D-Object-Based Analysis-Synthesis Coding,” COST 211 European Workshop on New Techniques for Coding of Video Signals at Very Low Bitrates, Hanover, Germany, 4.5.1-4.5.6 (Dec. 1-2, 1993), incorporated by reference herein.

### 3D Model of Head/Face

As previously indicated, a static model 230 of the user is obtained, for example, from a camera 220-1 focused on the user, or from a database of faces 220-2. For a more detailed discussion of the generation of three dimensional user models, see, for example, Lawrence S. Chen and Jörn Ostermann, “Animated Talking Head with Personalized 3D Head Model”, Proc. of 1997 Workshop of Multimedia Signal Processing, 274-279, Princeton, N.J. (Jun. 23-25, 1997), incorporated by reference herein. In addition, as previously indicated, the Cyberscan optical measurement system, commercially available from CyberScan Technologies of Newtown, Pa., can be used to obtain the static models can be used to obtain the static models.

Generally, a geometry model captures the shape of the user's head in three dimensions. The geometry model is typically in the form of range data. An appearance model captures the texture and color of the surface of the user's head. The appearance model is typically in the form of color data. Finally, an expression model captures the non-rigid deformation of the user's face that conveys facial expression, lip motion and other information.

FIG. 4 is a flow chart describing an exemplary implementation of the face synthesis process 400. As previously indicated, the face synthesis process 400 modifies the user model 230 according to the parameters generated by the facial analysis process 300. As shown in FIG. 4, the face synthesis process 400 initially retrieves the parameters generated by the facial analysis process 300 during step 410.

Thereafter, the face synthesis process 400 utilizes the head pose parameters during step 420 to rotate, translate and/or rescale the static model 230 to fit the position of the actor to be replaced in the input image sequence 110. The face synthesis process 400 then utilizes the facial expression parameters during step 430 to deform the static model 230 to match the facial expression of the actor to be replaced in the input image sequence 110. Finally, the face synthesis process 400 utilizes the illumination parameters during step 440 to adjust a number of features of the image of the static model 230, such as color, intensity, contrast, noise and shadows, to match the properties of the input image sequence 110. Thereafter, program control terminates.

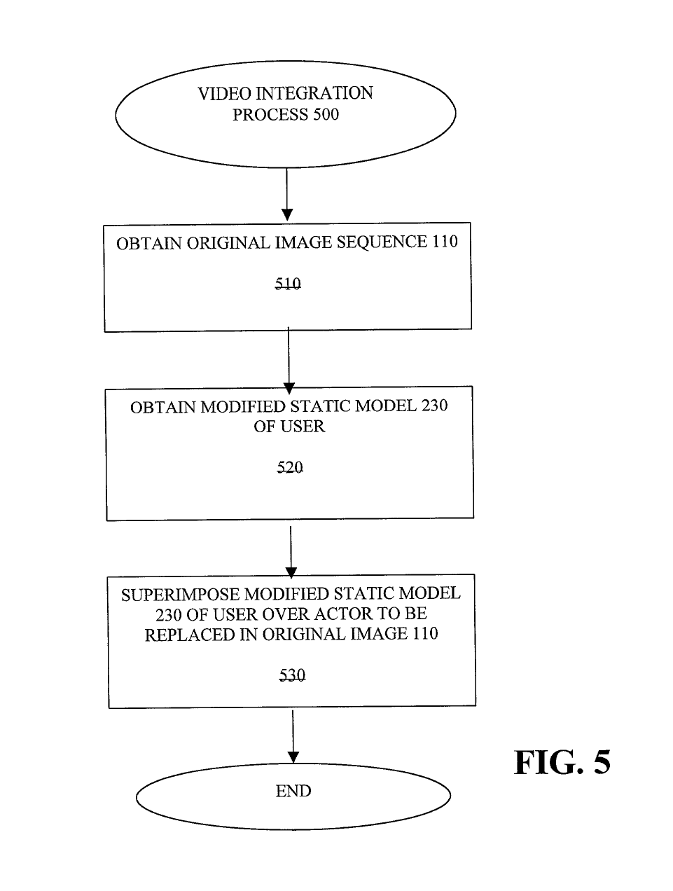

FIG. 5 is a flow chart describing an exemplary implementation of the video integration process 500. As previously indicated, the video integration process 500 superimposes the modified user model over the actor in the original image sequence 110 to produce an output video sequence 180 containing the user in the position of the original actor. As shown in FIG. 5, the video integration process 500 initially obtains the original image sequence 110 during step 510. The video integration process 500 then obtains the modified static model 230 of the user from the face synthesis process 400 during step 520.

The video integration process 500 thereafter superimposes the modified static model 230 of the user over the image of the actor in the original image 110 during step 530 to generate the output image sequence 180 containing the user with the position, pose and facial expression of the actor. Thereafter, program control terminates.

It is to be understood that the embodiments and variations shown and described herein are merely illustrative of the principles of this invention and that various modifications may be implemented by those skilled in the art without departing from the scope and spirit of the invention.

What is claimed is:

1. A method for replacing an actor in an original image with an image of a second person, comprising:
analyzing said original image to determine at least one parameter of said actor;
obtaining a static model of said second person;
modifying said static model according to said determined parameter; and
superimposing said modified static model over at least a corresponding portion of said actor in said image.

2. The method of claim 1, wherein said superimposed image contains at least a corresponding portion of said second person in the position of said actor.

3. The method of claim 1, wherein said parameter includes a head pose of said actor.

4. The method of claim 1, wherein said parameter includes a facial expression of said actor.

5. The method of claim 1, wherein said parameter includes illumination properties of said original image.

6. The method of claim 1, wherein said static model is obtained from a database of faces.

7. The method of claim 1, wherein said static model is obtained from one or more images of said second person.

8. A method for replacing an actor in an original image with an image of a second person, comprising:
analyzing said original image to determine at least one parameter of said actor; and
replacing at least a portion of said actor in said image with a static model of second person, wherein said static model is modified according to said determined at least one parameter.

9. The method of claim 8, wherein said superimposed image contains at least a corresponding portion of said second person in the position of said actor.

10. The method of claim 8, wherein said parameter includes a head pose of said actor.

11. The method of claim 8, wherein said parameter includes a facial expression of said actor.

12. The method of claim 8, wherein said parameter includes illumination properties of said original image.

13. The method of claim 8, wherein said static model is obtained from a database of faces.

14. The method of claim 8, wherein said static model is obtained from one or more images of said second person.

15. A system for replacing an actor in an original image with an image of a second person, comprising:
a memory that stores computer-readable code; and
a processor operatively coupled to said memory, said processor configured to implement said computer-readable code, said computer-readable code configured to:
analyze said original image to determine at least one parameter of said actor;
obtain a static model of said second person;
modify said static model according to said determined parameter; and
superimpose said modified static model over at least a corresponding portion of said actor in said image.

16. A system for replacing an actor in an original image with an image of a second person, comprising:
a memory that stores computer-readable code; and
a processor operatively coupled to said memory, said processor configured to implement said computer-readable code, said computer-readable code configured to:
analyze said original image to determine at least one parameter of said actor; and
replace at least a portion of said actor in said image with a static model of second person, wherein said static model is modified according to said determined parameters.

17. An article of manufacture for replacing an actor in an original image with an image of a second person, comprising:
a computer readable medium having computer readable code means embodied thereon, said computer readable program code means comprising:
a step to analyze said original image to determine at least one parameter of said actor;
a step to obtain a static model of said second person;
a step to modify said static model according to said determined parameter; and
a step to superimpose said modified static model over at least a corresponding portion of said actor in said image.

18. An article of manufacture for replacing an actor in an original image with an image of a second person, comprising:
a computer readable medium having computer readable code means embodied thereon, said computer readable program code means comprising:
a step to analyze said original image to determine at least one parameter of said actor; and
a step to replace at least a portion of said actor in said image with a static model of second person, wherein said static model is modified according to said determined parameters.
